(19) United States
(12) Patent Application Publication
(10) Pub. No.: US 2026/0281451 A1
(43) Pub. Date: Sep. 17, 2026

(54) SUPPLEMENTAL ENHANCEMENT MESSAGE (SEI) PROCESSING FOR VIDEO CODING

(71) Applicant: QUALCOMM Incorporated, San Diego, CA (US)

(72) Inventor: Yong He, San Diego, CA (US)

(21) Appl. No.: 19/540,152

(22) Filed: Feb. 13, 2026

Related U.S. Application Data
(60) Provisional application No. 63/772,061, filed on Mar. 14, 2025.

(51) Int. Cl. H04N 19/70; H04N 19/46

(52) U.S. Cl. CPC H04N 19/70; H04N 19/46

(57) ABSTRACT

An example device for decoding video data includes a memory to store video data and a processing system implemented in circuitry and to determine a value for a first syntax element of a supplemental enhancement information (SEI) processing order (SPO) SEI message of a video bitstream, the first syntax element indicating whether an SEI message of the video bitstream is included in a processing order nesting (PON) SEI message of the video bitstream; and when the value for the first syntax elements indicates that the SEI message is not included in the PON SEI message, determine that the SPO SEI message includes a value for a second syntax element, the second syntax element indicating whether a third syntax element is included for the SEI message in the SPO SEI message, the third syntax element indicating a number of prefix bits included for the SEI message in the SPO SEI message.

This application claims the benefit of U.S. Provisional Application No. 63/772,061, filed Mar. 14, 2025, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for processing supplemental enhancement information (SEI) messages for video data of a video bitstream.

In one example, a method of processing video data includes: processing a supplemental enhancement information (SEI) processing order (SPO) SEI message of a video bitstream to determine a processing chain comprising a plurality of SEI message types; determining, for each SEI message type in the plurality of SEI message types in the SPO SEI message, a set of syntax elements including a payload type, a processing order value, and at least one sub-chain indicator; partitioning the plurality of SEI messages into one or more sub-chains based on the at least one sub-chain indicator to form a set of partitions of SEI messages; and processing the plurality of SEI messages according to the processing order value and the set of partitions of SEI messages.

In another example, a device for processing video data includes: a memory configured to store video data; and a processing system implemented in circuitry and configured to: process a supplemental enhancement information (SEI) processing order (SPO) SEI message of a video bitstream to determine a processing chain comprising a plurality of SEI message types; determine, for each SEI message type in the plurality of SEI message types in the SPO SEI message, a set of syntax elements including a payload type, a processing order value, and at least one sub-chain indicator; process the plurality of SEI messages into one or more sub-chains based on the at least one sub-chain indicator to form a set of partitions of SEI messages; and process the plurality of SEI messages according to the processing order value and the set of partitions of SEI messages.

In another example, a method of processing video data includes: processing a supplemental enhancement information (SEI) processing order (SPO) SEI message of a video bitstream to determine a processing chain for a plurality of SEI message types; for each SEI message type of the plurality of SEI message types that has a payload type other than an ITU-T T.35 payload byte and a user data payload byte: determining an SEI prefix indication from the SPO SEI message, the SEI prefix indication comprising a bit string that follows an SEI payload syntax of a particular payload type; and extracting a number of complete syntax elements starting from a first syntax element in the SEI payload from the bit string.

In another example, a device for processing video data includes: a memory configured to store video data; and a processing system implemented in circuitry and configured to: process a supplemental enhancement information (SEI) processing order (SPO) SEI message of a video bitstream to determine a processing chain for a plurality of SEI message types; for each SEI message type of the plurality of SEI message types that has a payload type other than an ITU-T T.35 payload byte and a user data payload byte: determine an SEI prefix indication from the SPO SEI message, the SEI prefix indication comprising a bit string that follows an SEI payload syntax of a particular payload type; and extract a number of complete syntax elements starting from a first syntax element in the SEI payload from the bit string.

In another example, a method of processing video data includes: processing a supplemental enhancement information (SEI) processing order (SPO) SEI message of a video bitstream to determine a processing chain for a plurality of SEI message types; determining a value of a sub-chain count syntax element of the SPO SEI message, the value specifying a number of sub-chains included in the SPO SEI message; determining, for an SEI message type in the plurality of SEI message types, a sub-chain syntax element specifying a sub-chain to which the SEI message type belongs; partitioning the processing chain into one or more sub-chains; and processing the SEI message type as part of the sub-chain to which the SEI message type belongs.

In another example, a device for processing video data includes: a memory configured to store video data; and a processing system implemented in circuitry and configured to: process a supplemental enhancement information (SEI) processing order (SPO) SEI message of a video bitstream to determine a processing chain for a plurality of SEI message types; determine a value of a sub-chain count syntax element of the SPO SEI message, the value specifying a number of sub-chains included in the SPO SEI message; determine, for an SEI message type in the plurality of SEI message types, a sub-chain syntax element specifying a sub-chain to which the SEI message type belongs; partition the processing chain into one or more sub-chains; and process the SEI message type as part of the sub-chain to which the SEI message type belongs.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a flowchart illustrating an example method of processing a video bitstream including a supplemental enhancement information (SEI) processing order (SPO) SEI message including a payload type, a processing order value, and at least one sub-chain indicator per techniques of this disclosure.

FIG. 7 is a flowchart illustrating an example method of processing a video bitstream including an SPO SEI message including various SEI message types other than those including payload types of ITU-T T.35 payload byte and a user data payload byte per techniques of this disclosure.

FIG. 8 is a flowchart illustrating an example method of processing a video bitstream including an SPO SEI message including various sub-chains per techniques of this disclosure.

### DETAILED DESCRIPTION

Video data may be encapsulated into segments, such as individually retrievable video files. Coded video segments may be organized into network abstraction layer (NAL) units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, coding unit (CU), and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not be repeated for each sequence or picture, hence, coding efficiency may be improved. Furthermore, the use of parameter sets may enable out-of-band transmission of the header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages generally correspond to the normative part of some standard specifications, and thus are not always mandatory for standard compliant decoder implementation. SEI messages may include sequence level SEI messages and picture level SEI messages. Some sequence level information may be contained in SEI messages, such as scalability information SEI messages in the example of scalable video coding (SVC) and view scalability information SEI messages in multiview video coding (MVC). These example SEI messages may convey information on, e.g., extraction of operation points and characteristics of the operation points.

The Versatile Supplementary Enhancement Information (VSEI) standard, ITU-T H.274 and ISO/IEC 23002-7, specifies video usability information (VUI) and some SEI messages used in versatile video coding (VVC) bitstreams. The SEI mechanism enables video encoders to include metadata in the bitstream that is not required for the correct decoding of sample values (e.g., pixel values) of output pictures, but can be used for various other purposes. Video encoders can include any number of SEI NAL units in an access unit, and each SEI NAL unit may contain one or more SEI messages. Specifications and systems using VVC may require encoders to generate certain SEI messages or may define specific handling of particular types of received SEI messages.

One SEI message is an SEI processing order (SPO) SEI message. The SPO SEI message includes information indicating the preferred processing order, as determined by the encoder (i.e., the content producer), for a group of types of SEI messages that may be present in a coded layer video sequence (CLVS). Another SEI message is a processing order nesting (PON) SEI message. The PON SEI message includes one or more SEI messages that should be applied only as parts of a processing chain identified by an associated SEI processing order SEI message.

Certain problems may arise from the use of such SEI messages. For example, a syntax element may indicate if a number of prefix bits of a particular SEI message are included in the SPO SEI message, e.g., a po_sei_prefix_flag[i] syntax element that indicates if a certain number of prefix bits of an i^{th} SEI message are present in the SPO SEI message. Another syntax element may indicate if a particular SEI message is included in a PON SEI message, e.g., a po_sei_wrapping_flag[i] syntax element may indicate if an i^{th} SEI message is included in the PON SEI message. When the po_sei_wrapping_flag[i] syntax element has a value of 1, it is not necessary to signal the prefix bits of the i^{th} SEI message, because the same content is already present in the PON SEI message.

Video coding systems may use supplemental enhancement information (SEI) messages to assist in decoding, rendering, and display processes. An SEI processing order (SPO) SEI message indicates a preferred processing order for a group of SEI messages. However, existing signaling mechanisms within the SPO SEI message contain redundancies and ambiguities. For instance, the conventional syntax signals prefix bits for an SEI message even when the SEI message is encapsulated in a processing order nesting (PON) SEI message, providing the associated context without the prefix bits. Additionally, requirements for SEI prefix indications to align with complete syntax element boundaries have proven problematic for payload types with externally specified syntax, such as ITU-T T.35 payloads or user data payloads, where boundary determination falls outside the scope of the standard.

Further challenges arise in defining processing chains and sub-chains. Current specifications provide complexity and usage information for the entire processing chain but lack granularity for individual sub-chains, preventing decoders from selectively executing viable sub-chains based on resource availability. Furthermore, identifying SEI messages belonging to specific sub-chains remains difficult when multiple messages share a processing order value without explicit indexing. Inconsistencies may also occur between the intended usage indicators (e.g., for human viewing or machine analysis) in the SPO SEI message and the definitions within specific component SEI messages, such as Neural-network post-filter characteristics (NNPFC) or Annotated Regions (AR) SEI messages.

To address these technical challenges, the techniques of this disclosure introduce constraints and signaling enhancements to the SPO SEI message. The disclosure conditions the presence of prefix indication flags on whether the SEI message is included in a PON SEI message, thereby eliminating redundant signaling. Exceptions are added to the prefix indication boundary constraints to accommodate ITU-T T.35 payloads and user data payloads. The techniques also define explicit signaling for sub-chain indices and provide separate usage and complexity information for sub-chains and mandatory processing stages. These modifications may enhance consistency between global and local usage indicators, reduce bitstream redundancy, and enable decoders to efficiently identify and execute appropriate processing sub-chains.

An SPO SEI message may specify that each SEI prefix indication is a bit string that contains a number of complete syntax elements starting from an ordinal first syntax element in the SEI payload. However, syntax elements of a user registered by an ITU-T T.35 SEI message may contain externally-specified syntax elements, and a determination of boundaries of such externally-specified syntax elements is outside the scope of the standard specification.

An SPO SEI message may include syntax elements related to a human viewing indicator (e.g., po_for_human_viewing_idc) and a machine analysis indicator (po_for_machine_analysis_idc) to indicate intended optimal usage of video resulting from the processing chain. When a Neural-network post-filter characteristics (NNPFC) SEI message is the ordinal last SEI message of the processing chain, the values for the po_for_human_viewing_idc and po_for_machine_analysis_idc are conventionally set equal to nnpfc_for_human_viewing_idc and nnpfc_for_machine_analysis_idc syntax elements, respectively, of the associated NNPFC SEI message. These same constraints also conventionally apply when the ordinal last SEI message of the processing chain is an Encoder Optimization Information (EOI) SEI message or an Annotated Regions SEI message.

An SPO SEI message may specify the complexity and usage information of the processing chain. This disclosure recognizes that it may be beneficial to indicate the complexity or usage information of one or more, e.g., each, sub-chain, so that the video decoder may select a corresponding sub-chain instead of the entire processing chain, based on capabilities and a capacity of the video decoder.

A syntax element corresponding to an SEI message may indicate whether the SEI message starts or ends a sub-chain of the processing chain. For example, a po_sei_importance_flag[i] and/or a po_sei_processing_degree_flag[i] syntax element may indicate whether an i^{th} SEI message is a start or an end of a sub-chain.

Conventionally, there is no preferred order of processing among SEI messages that share the same po_sei_processing_order value. Thus, this disclosure recognizes that it is difficult to identify an SEI message belonging to a particular sub-chain if the po_sei_processing_order value for that SEI message is the same as the po_sei_processing_order value for an SEI message that starts or ends a sub-chain.

It is also unclear, based on conventional definitions, whether an SPO SEI message can be included in another SPO SEI message and/or a PON SEI message.

An SPO SEI message may specify that, “Each type of SEI message in the processing chain indicated by an SPO SEI message is identified by the syntax elements po_sei_payload_type[i], po_sei_wrapping_flag[i], po_sei_processing_order[i], and, when present, po_num_bits_in_prefix_indication_minus1[i] and po_prefix_data_bit[i][j].” This implies two types of SEI messages in the processing chain indicated by an SPO SEI message may have the same values of po_sei_payload_type, po_sei_wrapping_flag, and, when present, po_num_bits_in_prefix_indication_minus1 and po_prefix_data_bit but different po_sei_processing_order values.

Boyce et al., “Additional SEI messages for VSEI version 4 (Draft 5),” document JVET-AK2006-v2, 37^{th} Meeting, Geneva, CH, 14-22 Jan. 2025, defines semantics for certain SEI syntax elements as follows:

po_for_human_viewing_idc equal to 3 specifies that the intended optimal usage of the video resulting from the processing chain specified by this SPO SEI message includes for human viewing. po_for_human_viewing_idc equal to 2 specifies that the video resulting from the processing chain specified by this SPO SEI message is suitable but not specifically optimized for human viewing. po_for_human_viewing_idc equal to 1 specifies that the video resulting from the processing chain specified by this SPO SEI message is unsuitable for human viewing. po_for_human_viewing_idc equal to 0 specifies that it is unknown if the video resulting from the processing chain specified by this SPO SEI message is suitable for human viewing.

po_for_machine_analysis_idc equal to 3 specifies that the intended optimal usage of the video resulting from the processing chain specified by this SPO SEI message includes machine analysis. po_for_machine_analysis_idc equal to 2 specifies that the video resulting from the processing chain specified by this SPO SEI message is suitable but not specifically optimized for machine analysis.

po_for_machine_analysis_idc equal to 1 specifies that the video resulting from the processing chain specified by this SPO SEI message is unsuitable for machine analysis. po_for_machine_analysis_idc equal to 0 specifies that it is unknown if the video resulting from the processing chain specified by this SPO SEI message is suitable for machine analysis.

po_sei_wrapping_flag[i] equal to 1 specifies that an SEI message that applies as the i-th SEI message type in the processing chain specified in this SPO SEI message, if present, is an SEI message that is included in a PON SEI message for which both of the following conditions are true:
pon_target po_id[j] with any value of j is equal to po_id.
There is a k-th loop entry in the processing order nesting SEI message such that the payloadType of the k-th nested SEI message is equal to po_sei_payload_type[i] and pon_processing_order[k] is equal to po_sei_processing_order[i].
   po_sei_wrapping_flag[i] equal to 0 specifies that an SEI message that applies as the i-th SEI message type in the processing chain specified in this SPO SEI message, if present, is an SEI message that is not included in a PON SEI message and for which both of the following conditions are true:
The payloadType of the SEI message is equal po_sei_payload_type[i].
po_sei_prefix_flag[i] is equal to 0, or when po_sei_prefix_flag[i] is equal to 1, the payload of the SEI message starts with the values of po_sei_prefix_data_bit[i][j].

po_sei_importance_flag[i] affects the derivation of PoSeiList, which is the list of SEI messages that a decoding system should process for a particular picture picA, as specified below.

po_sei_processing_degree_flag[i] affects the derivation of PoSeiList as specified below.

A processing chain may contain zero or more sub-chains. A sub-chain includes such SEI message types that either all these SEI message types should be processed by a decoding system or, if the decoding system cannot interpret or does not support one or more of these SEI message types, none of the SEI message types of the sub-chain should be processed. The SEI message types that belong to a sub-chain are determined by the values of po_sei_importance_flag[i] and po_sei_processing_degree_flag[i] as specified below.

po_sei_payload_type[i] specifies the payloadType value of the i-th type of SEI message.

po_sei_prefix_flag[i] equal to 1 specifies that po_num_bits_in_prefix_indication_minus1[i] and some po_sei_prefix_data_bit[i][j] syntax elements are present. po_sei_prefix_flag[i] equal to 0 specifies that these syntax elements are not present. The value of po_sei_payload_type[i] for each i in the range of 0 to po_num_sei_messages_minus2+1, inclusive, shall be equal to a value in SeiProcessingOrderSeiList. When po_sei_payload_type[i] is equal to any value in SpoProcessSeiList, the i-th type of SEI message indicates a process. spoPropertySeiList is set to include the payloadType values included in SeiProcessingOrderSeiList excluding the payloadType values included in SpoProcessSeiList. When po_sei_payload_type[i] is equal to any value in spoPropertySeiList, the i-th type of SEI message indicates a property after applying the processes, if any, indicated by the SEI message types of the earlier processing stages, if any, of the processing chain.

po_sei_processing_order[i] indicates the preferred order of processing of the i-th type of SEI message for which preferred processing order information is provided in the SPO SEI message. For any two different integer values of m and n, po_sei_processing_order[m] less than po_sei_processing_order[n] indicates that the type of SEI message associated with index m should be processed before the type of SEI message associated with index n, and po_sei_processing_order[m] equal to po_sei_processing_order[n] indicates that there is no preferred order of processing between the types of SEI messages associated with indexes m and n (e.g., they can indicate different properties that are both applicable at that stage, or one can indicate a property and the other can indicate a process). For i greater than 0, po_sei_processing_order[i] shall be greater than or equal to po_sei_processing_order[i−1].

nnpfc_for_human_viewing_idc equal to 3 specifies that the intended optimal usage of the video resulting from the NNPF process includes human viewing. nnpfc_for_human_viewing_idc equal to 2 specifies that the video resulting from the NNPF process is suitable but not specifically optimized for human viewing. nnpfc_for_human_viewing_idc equal to 1 specifies that the video resulting from the NNPF process is unsuitable for human viewing. nnpfc_for_human_viewing_idc equal to 0 specifies that it is unknown if the video resulting from the NNPF process is suitable for human viewing. When not present, nnpfc_for_human_viewing_idc is inferred to be equal to 0.

nnpfc_for_machine_analysis_idc equal to 3 specifies that the intended optimal usage of the video resulting from the NNPF process includes machine analysis. nnpfc_for_machine_analysis_idc equal to 2 specifies that the video resulting from the NNPF process is suitable but not specifically optimized for machine analysis. nnpfc_for_machine_analysis_idc equal to 1 specifies that the video resulting from the NNPF process is unsuitable for machine analysis. nnpfc_for_machine_analysis_idc equal to 0 specifies that it is unknown if the video resulting from the NNPF process is suitable for machine analysis. When not present, nnpfc_for_machine_analysis_idc is inferred to be equal to 0.

po_num_bits_in_prefix_indication_minus1[i] and po_sei_prefix_data_bit[i][j], when present, have the same semantics as the num_bits_in_prefix_indication_minus1[i] and sei_prefix_data_bit[i][j] syntax elements of the SEI prefix indication SEI message, with prefix_sei_payload_type replaced by po_sei_payload_type[i]. When more than one SPO SEI message with a particular value of po_id is present in a CLVS, the values of po_for_human_viewing_idc, po_for_machine_analysis_idc, po_num_sei_messages_minus2, po_breadth_first_flag and, for each value of i, the values of po_sei_wrapping_flag[i], po_sei_importance_flag[i], po_sei_processing_degree_flag[i], po_sei_payload_type[i], po_sei_prefix_flag[i], po_sei_processing_order[i] shall be the same as in the other SPO SEI messages in the CLVS with the same value of po_id.

po_byte_alignment_bit_equal_to_one shall be equal to 1.

Furthermore, in JVET-AK2006-v2, “processing order” may be abbreviated as “po,” e.g., in syntax element names.

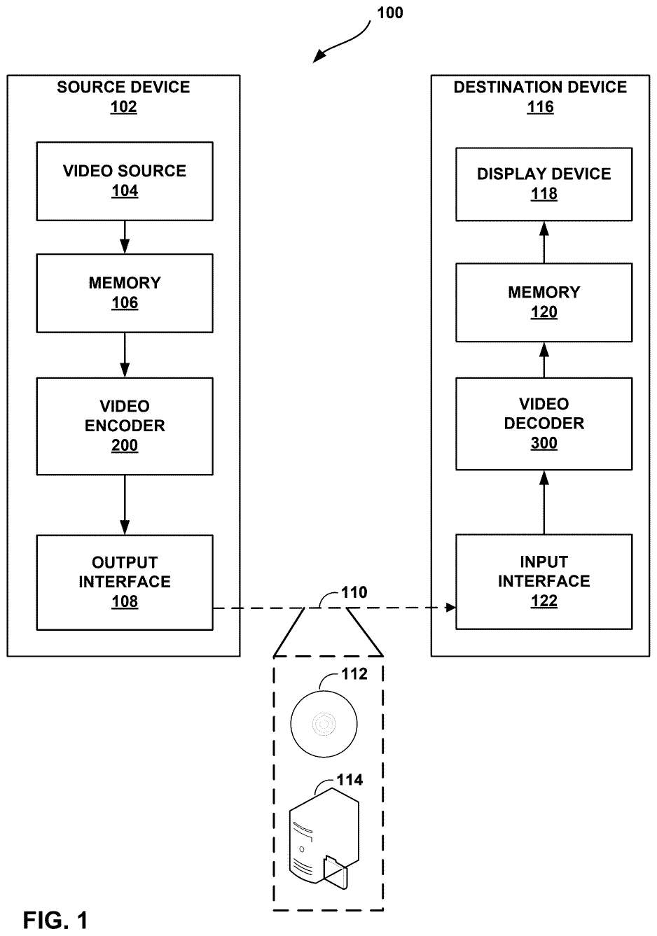

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming devices, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for processing SEI messages of this disclosure. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for processing SEI messages per this disclosure. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, Digital Versatile Discs (DVDs), Compact Disc Read-Only Memories (CD-ROMs), flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. Example audio codecs include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Audio.

Video encoder 200 and video decoder 300 each may be implemented as any of a variety of suitable encoder and/or decoder circuitry of a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that process SEI messages.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may have N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs to exploit cross-component correlations. Different color components may share the same filters (including network structure and model parameters) or each component may have its own specific filters.

The filtering process can also be generalized as follows:

$${R}^{′} ( i , j ) = R ( i , j ) + NN\_filter \_residual \_ouput ( R )$$

Here, R(i, j) represents a reconstructed sample at position (i, j) in the picture, R′(i, j) represents the filtered version of the reconstructed sample, and
NN_filter_residual_output(R) represents the intermediate samples discussed above that are calculated by the NN filter. The model structure and model parameters of NN-based filter(s) can be pre-defined and be stored at video encoder 200 and video decoder 300. The filters can also be signalled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PRELU layer is an activation function used in neural networks, and is a variant of the ReLU (Rectified Linear Unit) activation function. As described above, the convolution layer outputs feature maps, each corresponding to one filter, representing detected features in the input. Following the convolution layer, the PRELU layer applies the PRELU activation function to each element of the feature maps produced by the convolution layer. For positive values, the PRELU layer acts like a standard ReLU, passing the value through. For negative values, instead of setting them to zero (e.g., as ReLU does), the PRELU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a frame, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g. for 4:2:0 representation, or can be up-sampled to the Luma resolution to achieve per-pixel representation. Similarly, QP, BS, partitioning, or coding mode information can be provided at lower resolution, including cases with a single value per frame, slice or processing block (e.g. QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bitstream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, video encoder 200 may add one or more SEI messages to a bitstream, and video decoder 300 may use the SEI messages when decoding and/or processing video data of the bitstream. Furthermore, in an SEI message, such as a picture orientation SEI message, video encoder 200 may condition inclusion of a po_sei_prefix_flag[i] in an SEI processing order payload on the value of the po_sei_wrapping_flag[i]. For example, video encoder 200 may only signal a value for po_sei_prefix_flag[i] when the value of po_sei_wrapping_flag[i] is 0 (false). Thus, video decoder 300 may determine that data following a po_sei_payload_type[i] syntax element in the SEI processing order payload corresponds to the po_sei_prefix_flag[i] when the po_sei_wrapping_flag[i] has a value of 0 or to po_sei_processing_order[i] when the po_sei_wrapping_flag[i] has a value of 1. Thus, the po_sei_prefix_flag[i] syntax element may be present in the SEI processing order payload only when the value of the po_sei_wrapping_flag[i] has a value equal to 0. Table 1 below represents an example of modified syntax for the picture orientation SEI message per techniques of this disclosure, where “*added:*” represents the additional condition per techniques of this disclosure:

TABLE 1
Picture orientation SEI message

| | Descriptor |
|---|---|
| sei_processing_order( payloadSize) { | |
| po_id | u(8) |
| ... | |
| for ( i = 0, I < po_num_sei_messages_minus2 + 2; i++ | |
| ) { | |
| po_sei_wrapping_flag[ i ] | u(1) |
| po_sei_importance_flag[ i ] | u(1) |
| po_sei_processing_degree_flag[ i ] | u(1) |
| po_sei_payload_type[ i ] | u(12) |
| *added* if ( ! po_sei_wrapping_flag[ i ]) | |
| po_sei_prefix_flag[ i ] | u(1) |
| po_sei_processing_order[ i ] | u(8) |
| } | |
| ... | |
| } | |

Semantics of the po_sei_prefix_flag[i] may then be defined as follows: po_sei_prefix_flag[i] equal to 1 specifies that po_num_bits_in_prefix_indication_minus1[i] and some po_sei_prefix_data_bit[i][j] syntax elements are present. po_sei_prefix_flag[i] equal to 0 specifies that these syntax elements are not present. When po_sei_prefix_flag[i] is not present, it is inferred to be equal to 0.

Additionally or alternatively, video encoder 200 and video decoder 300 may be configured to exclude the ITU-T T.35 SEI message from the SEI prefix indication constraint as follows (where “*added:*” and “*end addition*” demark the additional semantics per techniques of this disclosure): The SPO SEI message can carry one or more SEI prefix indications of a particular payloadType. When present, each SEI prefix indication is a bit string that follows the SEI payload syntax of that value of payloadType and contains a number of complete syntax elements starting from the first syntax element in the SEI payload *added:*, unless it is a bit within an itu_t_t35_payload_byte or user_data_payload_byte *end addition*. These SEI prefix indications should provide sufficient information to determine the specific processing order for types of SEI messages having the same value of payloadType but a different preferred processing order. *added:* NOTE—The exception for itu_t_t35_payload_byte and user_data_payload_byte is provided because these syntax elements can contain externally-specified syntax elements, and the determination of the boundaries of such externally-specified syntax elements is a matter outside the scope of this Specification. **end addition*.

Video encoder 200 and video decoder 300 may also be configured according to the following requirements for bitstream conformance:
It is a requirement of bitstream conformance that the value of po_for_human_viewing_idc and po_for_machine_analysis_idc, shall be equal to the value of nnpfc_for_human_viewing_idc and nnpfc_for_machine_analysis_idc of the associated NNPFC SEI message when the associated NNPFC SEI message has the greatest value of po_sei_processing_order among the SEI messages associated with the SPO SEI message.
It is a requirement of bitstream conformance that the value of po_for_human_viewing_idc and po_for_machine_analysis_idc, shall be equal to the value of eoi_for_human_viewing_idc and eoi_for_machine_analysis_idc of the associated Encoder optimization information (EOI) SEI message when the associated EOI SEI message has the greatest value of po_sei_processing_order among the SEI messages associated with the SPO SEI message.
It is a requirement of bitstream conformance that the value of po_for_human_viewing_idc shall not be equal to 3 when the value of ar_not_optimized_for_viewing_flag of the associated Annotated Regions (AR) SEI message is equal to 1 and the associated Annotated Regions SEI message has the greatest value of po_sei_processing_order among the SEI messages associated with the SPO SEI message.

Thus, for example, video encoder 200 may be configured to set the values of po_for_human_viewing_idc and nnpfc_for_human_viewing_idc to the same value when the associated NNPFC SEI message has the greatest value of po_sei_processing_order among the SEI messages associated with the SPO SEI message, and video decoder 300 may be configured to determine that these values are equal when the associated NNPFC SEI message has the greatest value of po_sei_processing_order among the SEI messages associated with the SPO SEI message. Likewise, video encoder 200 may be configured to set the values of po_for_machine_analysis_idc and nnpfc_for_machine_analysis_idc to the same value when the associated NNPFC SEI message has the greatest value of po_sei_processing_order among the SEI messages associated with the SPO SEI message, and video decoder 300 may be configured to determine that these values are equal when the associated NNPFC SEI message has the greatest value of po_sei_processing_order among the SEI messages associated with the SPO SEI message.

Additionally or alternatively, video encoder 200 may be configured to set the values of po_for_human_viewing_idc and eoi_for_human_viewing_idc to the same value when the associated EOI SEI message has the greatest value of po_sei_processing_order among the SEI messages associated with the SPO SEI message, and video decoder 300 may be configured to determine that these values are equal when the associated EOI SEI message has the greatest value of po_sei_processing_order among the SEI messages associated with the SPO SEI message. Likewise, video encoder 200 may set the values of po_for_machine_analysis_idc and eoi_for_machine_analysis_idc to the same value when the associated EOI SEI message has the greatest value of po_sei_processing_order among the SEI messages associated with the SPO SEI message, and video decoder 300 may determine that these values are equal when the associated EOI SEI message has the greatest value of po_sei_processing_order among the SEI messages associated with the SPO SEI message.

Additionally or alternatively, when the value of ar_not_optimized_for_viewing_flag of the associated Annotated Regions (AR) SEI message is equal to 1 and the associated Annotated Regions SEI message has the greatest value of po_sei_processing_order among the SEI messages associated with the SPO SEI message, video encoder 200 may set the value of po_for_human_viewing_idc to a value other than 3, and video decoder 300 may determine that the value of po_for_human_viewing_idc is a value other than 3 when the value of ar_not_optimized_for_viewing_flag of the associated Annotated Regions (AR) SEI message is equal to 1 and the associated Annotated Regions SEI message has the greatest value of po_sei_processing_order among the SEI messages associated with the SPO SEI message.

Video encoder 200 and video decoder 300 may, alternatively, be configured according to the following alternative requirements for bitstream conformance:
It is a requirement of bitstream conformance that the value of po_for_human_viewing_idc and po_for_machine_analysis_idc, shall be equal to the value of nnpfc_for_human_viewing_idc and nnpfc_for_machine_analysis_idc of the i-th SEI message when an i-th SEI message is a NNPFC SEI message and i is equal to po_num_sei_messages_minus2+1.
It is a requirement of bitstream conformance that the value of po_for_human_viewing_idc and po_for_machine_analysis_idc, shall be equal to the value of eoi_for_human_viewing_idc and eoi_for_machine_analysis_idc of the (po_num_sei_messages_minus2+1)-th SEI message when (po_num_sei_messages_minus2+1)-th SEI message is an EOI SEI message.
It is a requirement of bitstream conformance that the value of po_for_human_viewing_idc shall not be equal to 3 when the (po_num_sei_messages_minus2+1)-th SEI message is an Annotated Regions SEI message with the value of ar_not_optimized_for_viewing_flag equal to 1.

Thus, for example, video encoder 200 may be configured to set the values of po_for_human_viewing_idc and nnpfc_for_human_viewing_idc to the same value when an i-th SEI message is a NNPFC SEI message and i is equal to po_num_sei_messages_minus2+1, and video decoder 300 may be configured to determine that these values are equal when an i-th SEI message is a NNPFC SEI message and i is equal to po_num_sei_messages_minus2+1. Likewise, video encoder 200 may be configured to set the values of po_for_machine_analysis_idc and nnpfc_for_machine_analysis_idc to the same value when an i-th SEI message is a NNPFC SEI message and i is equal to po_num_sei_messages_minus2+1, and video decoder 300 may be configured to determine that these values are equal when an i-th SEI message is a NNPFC SEI message and i is equal to po_num_sei_messages_minus2+1.

Additionally or alternatively, video encoder 200 may be configured to set the values of po_for_human_viewing_idc and eoi_for_human_viewing_idc to the same value when a (po_num_sei_messages_minus2+1)-th SEI message is an EOI SEI message, and video decoder 300 may be configured to determine that these values are equal when a (po_num_sei_messages_minus2+1)-th SEI message is an EOI SEI message. Likewise, video encoder 200 may set the values of po_for_machine_analysis_idc and eoi_for_machine_analysis_idc to the same value when a (po_num_sei_messages_minus2+1)-th SEI message is an EOI SEI message, and video decoder 300 may determine that these values are equal when a (po_num_sei_messages_minus2+1)-th SEI message is an EOI SEI message.

Additionally or alternatively, when the (po_num_sei_messages_minus2+1)-th SEI message is an Annotated Regions SEI message with the value of ar_not_optimized_for_viewing_flag equal to 1, video encoder 200 may set the value of po_for_human_viewing_idc to a value other than 3, and video decoder 300 may determine that the value of po_for_human_viewing_idc is a value other than 3 when the (po_num_sei_messages_minus2+1)-th SEI message is an Annotated Regions SEI message with the value of ar_not_optimized_for_viewing_flag equal to 1.

Video encoder 200 and video decoder 300 may, alternatively, be configured according to the following alternative requirements for bitstream conformance:
It is a requirement of bitstream conformance that the value of po_for_human_viewing_idc and po_for_machine_analysis_idc, shall be equal to the value of nnpfc_for_human_viewing_idc and nnpfc_for_machine_analysis_idc of the associated NNPFC SEI message when the associated NNPFC SEI messages is a mandatory processing stage of the SPO SEI message.
It is a requirement of bitstream conformance that the value of po_for_human_viewing_idc and po_for_machine_analysis_idc, shall be equal to the value of eoi_for_human_viewing_idc and eoi_for_machine_analysis_idc of the associated Encoder optimization information (EOI) SEI message when the EOI SEI message is a mandatory processing stage of the SPO SEI message.
It is a requirement of bitstream conformance that the value of po_for_human_viewing_idc shall not be equal to 3 when po_sei_processing_order of the associated Annotated Regions SEI message is a mandatory processing stage of the SPO SEI message and the value of ar_not_optimized_for_viewing_flag is equal to 1.

Thus, for example, video encoder 200 may be configured to set the values of po_for_human_viewing_idc and nnpfc_for_human_viewing_idc to the same value when the associated NNPFC SEI messages is a mandatory processing stage of the SPO SEI message, and video decoder 300 may be configured to determine that these values are equal when the associated NNPFC SEI messages is a mandatory processing stage of the SPO SEI message. Likewise, video encoder 200 may be configured to set the values of po_for_machine_analysis_idc and nnpfc_for_machine_analysis_idc to the same value when the associated NNPFC SEI messages is a mandatory processing stage of the SPO SEI message, and video decoder 300 may be configured to determine that these values are equal when the associated NNPFC SEI messages is a mandatory processing stage of the SPO SEI message.

Additionally or alternatively, video encoder 200 may be configured to set the values of po_for_human_viewing_idc and eoi_for_human_viewing_idc to the same value when the EOI SEI message is a mandatory processing stage of the SPO SEI message, and video decoder 300 may be configured to determine that these values are equal when the EOI SEI message is a mandatory processing stage of the SPO SEI message. Likewise, video encoder 200 may set the values of po_for_machine_analysis_idc and eoi_for_machine_analysis_idc to the same value when the EOI SEI message is a mandatory processing stage of the SPO SEI message, and video decoder 300 may determine that these values are equal when the EOI SEI message is a mandatory processing stage of the SPO SEI message.

Additionally or alternatively, when po_sei_processing_order of the associated Annotated Regions SEI message is a mandatory processing stage of the SPO SEI message and the value of ar_not_optimized_for_viewing_flag is equal to 1, video encoder 200 may set the value of po_for_human_viewing_idc to a value other than 3, and video decoder 300 may determine that the value of po_for_human_viewing_idc is a value other than 3 when po_sei_processing_order of the associated Annotated Regions SEI message is a mandatory processing stage of the SPO SEI message and the value of ar_not_optimized_for_viewing_flag is equal to 1.

Video encoder 200 and video decoder 300 may further be configured according to techniques for using the SPO SEI message when video decoder 300 is unable to process one or more SEI messages in SpoProcessSeiList.

A sub-chain may form part of a processing chain. Video encoder 200 and video decoder 300 may be configured to encode/decode values for a number of sub-chains in the processing chain (e.g., a po_num_sub_chain_minus1 syntax element) and, for each SEI message in a number of SEI messages, an SEI subchain index (e.g., a po_sei_subchain_idx[i] syntax element). Table 2 below represents an example of syntax elements for sub-chain indexes, e.g., to an SEI processing order SEI message, per this disclosure, where “*added:*” and “*end addition* represent additions to the syntax relative to JVET-AK2006-v2:

TABLE 2

```
*added*: po_num_sub_chain_minus1 *end addition*
for( i = 0, i < po_num_sei_messages_minus2 + 2; i++ ) {
  po_sei_wrapping_flag[ i ]
  po_sei_importance_flag[ i ]
  po_sei_processing_degree_flag[ i ]
  po_sei_payload_type[ i ]
  po_sei_prefix_flag[ i ]
  *added:* po_sei_subchain_idx[ i ] *end addition*
  po_sei_processing_order[ i ]
}
```

Semantics for these added syntax elements may be as follows per the techniques of this disclosure:

po_num_sub_chain_minus1 plus 1 specifies the number of sub-chains identified by the SEI processing order SEI message.

po_sei_subchain_idx[i] specifies the index of the sub-chain that the i-th SEI message belongs to. When not present, the value of po_sei_subchain_idx[i] is inferred to be equal to i.

Thus, video encoder 200 may signal, in an SEI processing order SEI message, a number of sub-chains in the SEI processing order SEI message, and for each SEI message, an index of the sub-chain to which the SEI message belongs. Likewise, video decoder 300 may determine a number of SEI messages for which sub-chains are specified, and for each of the SEI messages, the index of the sub-chain to which the SEI message belongs.

In case a sub-chain is skipped, the processing chain usage and complexity information may not be valid. Thus, video encoder 200 and video decoder 300 may be configured to code usage and complexity information for each sub-chain in the SPO SEI message. Table 3 below represents an example of such usage and complexity information:

TABLE 3

| | |
|---|---|
| po_sub_chain_info_present_flag | u(1) |
| if( po_sub_chain_info_present_flag ) { | |
| po_num_sub_chain_minus1 | u(6) |
| for( i = 0; i < po_num_sub_chain_minus1+ 1; i++ ) { | |
| po_sub_chain_usage_present_flag[ i ] | u(1) |
| if(po_sub_chain_usage_present_flag[ i ]) { | |
| po_sub_chain_for_human_viewing_idc[ i ] | u(2) |
| po_sub_chain_for_machine_analysis_idc[ i ] | u(2) |
| } | |
| po_sub_chain_complexity_info_present_flag[ i ] | u(1) |
| if(po_sub_chain_complexity_info_present_flag[ i ]) { | |
| po_sub_chain_parameter_type_idc[ i ] | u(2) |
| if( po_sub_chain_parameter_type_idc != 2 ) | |
| po_sub_chain_log2_parameter_bit_length_minus3 | u(2) |
| [ i ] | |
| po_sub_chain_num_parameters_idc[ i ] | u(6) |
| po_sub_chain_num_kmac_operations_idc[ i ] | ue(v) |
| po_sub_chain_total_kilobyte_size[ i ] | ue(v) |
| } | |
| } | |

Semantics for the syntax elements of Table 3 may be defined as follows:

po_sub_chain_info_present_flag equal to 1 specifies that the syntax elements that indicate the sub-chain information of invoking NNPFs in the sub-chains identified by the SEI processing order SEI message are present. po_sub_chain_info_present_flag equal to 0 specifies that no syntax elements that indicate the sub-chain information of invoking NNPFs in the sub-chain identified by the SEI processing order SEI message are present.

po_num_sub_chain_minus1 plus 1 specifies the number of sub-chains identified by the SEI processing order SEI message.

po_sub_chain_usage_present_flag[i] equal to 1 specifies that the syntax elements that indicate the usage of invoking NNPFs in the i-th sub-chain identified by the SEI processing order SEI message are present. po_sub_chain_usage_present_flag[i] equal to 0 specifies that no syntax elements that indicates the usage of invoking NNPFs in the i-th sub-chain identified by the SEI processing order SEI message are present.

po_sub_chain_complexity_present_flag[i] equal to 1 specifies that the syntax elements that indicate the complexity of invoking NNPFs in the i-th sub-chain identified by the SEI processing order SEI message are present.

po_sub_chain_complexity_present_flag[i] equal to 0 specifies that no syntax elements that indicates the complexity of invoking NNPFs in the i-th sub-chain identified by the SEI processing order SEI message are present.

The syntax elements, po_sub_chain_for_human_viewing_idc[i], po_sub_chain_for_machine_analysis_idc[i], po_sub_chain_log 2_parameter_bit_length_minus3[i], po_sub_chain_num_parameters_idc[i], po_sub_chain_num_kmac_operations_idc[i], po_sub_chain_total_kilobyte_size[i] are the usage and complexity information applied to the i-th sub-chain.

po_sub_chain_for_human_viewing_idc[i] equal to 3 specifies that the intended optimal usage of the video resulting from the i-th sub-chain specified by this SPO SEI message includes for human viewing. po_sub_chain_for_human_viewing_idc equal to 2 specifies that the video resulting from the i-th sub-chain specified by this SPO SEI message is suitable but not specifically optimized for human viewing.

po_sub_chain_for_human_viewing_idc equal to 1 specifies that the video resulting from the i-th sub-chain specified by this SPO SEI message is unsuitable for human viewing. po_sub_chain_for_human_viewing_idc equal to 0 specifies that it is unknown if the video resulting from the i-th sub-chain specified by this SPO SEI message is suitable for human viewing.

po_sub_chain_for_machine_analysis_idc[i] equal to 3 specifies that the intended optimal usage of the video resulting from the i-th sub-chain specified by this SPO SEI message includes machine analysis. po_sub_chain_for_machine_analysis_idc equal to 2 specifies that the video resulting from the i-th sub-chain specified by this SPO SEI message is suitable but not specifically optimized for machine analysis. po_sub_chain_for_machine_analysis_idc equal to 1 specifies that the video resulting from the i-th sub-chain specified by this SPO SEI message is unsuitable for machine analysis. po_sub_chain_for_machine_analysis_idc equal to 0 specifies that it is unknown if the video resulting from the i-th sub-chain specified by this SPO SEI message is suitable for machine analysis.

It is a requirement of bitstream conformance that the value of po_sub_chain_for_human_viewing_idc[i] and po_sub_chain_for_machine_analysis_idc[i] shall not be both equal to 1.

po_sub_chain_parameter_type_idc equal to 0 indicates that the NNPFs in the i-th sub-chain identified by the SEI processing order SEI message use only integer parameters. po_parameter_type_flag equal to 1 indicates that the NNPFs in the i-th sub-chain identified by the SEI processing order SEI message may use floating point or integer parameters. po_parameter_type_idc equal to 2 indicates that the NNPFs in the i-th sub-chain identified by the SEI processing order SEI message uses only binary parameters. po_parameter_type_idc equal to 3 is reserved for future use by ITU-T|ISO/IEC and shall not be present in bitstreams conforming to this edition of this document. Decoders conforming to this edition of this document shall ignore SPO SEI messages with po_parameter_type_idc equal to 3.

po_sub_chain_log 2_parameter_bit_length_minus3 equal to 0, 1, 2, and 3 indicates that the NNPFs in the i-th sub-chain identified by the SEI processing order SEI message do not use parameters of bit length greater than 8, 16, 32, and 64, respectively. When po_parameter_type_idc is present and po_log 2_parameter_bit_length_minus3 is not present, the NNPFs in the i-th sub-chain identified by the SEI processing order SEI message do not use parameters of bit length greater than 1.

po_sub_chain_num_parameters_idc indicates the maximum number of parameters needed by NNPFs in the i-th sub-chain identified by the SEI processing order SEI message in units of a power of 2048. po_num_parameters_idc equal to 0 indicates that the maximum number of parameters needed by NNPFs in the i-th sub-chain identified by the SEI processing order SEI message is unknown. The value of po_num_parameters_idc shall be in the range of 0 to 52, inclusive. Values of po_num_parameters_idc greater than 52 are reserved for future use by ITU-T|ISO/IEC and shall not be present in bitstreams conforming to this edition of this document. Decoders conforming to this edition of this document shall ignore SPO SEI messages with po_num_parameters_idc greater than 52.

po_sub_chain_num_kmac_operations_idc greater than 0 indicates that the maximum number of multiply-accumulate operations per sample of the NNPFs in the i-th sub-chain identified by the SEI processing order SEI message is less than or equal to po_num_kmac_operations_idc*1 000. po_num_kmac_operations_idc equal to 0 indicates that the maximum number of multiply-accumulate operations of the NNPFs in the i-th sub-chain identified by the SEI processing order SEI message is unknown. The value of po_num_kmac_operations_idc shall be in the range of 0 to 2³²−2, inclusive.

po_sub_chain_total_kilobyte_size greater than 0 indicates a total size in kilobytes required to store the uncompressed parameters for the NNPFs in the i-th sub-chain identified by the SEI processing order SEI message. The total size in bits is a number equal to or greater than the sum of bits used to store each parameter. po_total_kilobyte_size is the total size in bits divided by 8 000, rounded up. po_total_kilobyte_size equal to 0 indicates that the total size required to store the parameters for the NNPFs in the i-th sub-chain identified by the SEI processing order SEI message is unknown. The value of po_total_kilobyte_size shall be in the range of 0 to 2³²−2, inclusive.

In some examples, video encoder 200 may include an extension mechanism at the end of the SPO SEI message to support future extensions and signal complexity information for root processes (e.g., mandatory processing stages). Video encoder 200 may signal a ‘po_spo_extension_bits’ syntax element. When ‘po_spo_extension_bits’ is greater than 0, it specifies the length in bits of a ‘po_reserved_spo_extension’ data block. If ‘po_spo_extension_bits’ is equal to 0, the extension data is not present. Within the extension data, video encoder 200 may signal a ‘po_root_complexity_info_present_flag’. If this flag is equal to 1, video encoder 200 signals complexity information for the root processes identified by the SPO SEI message.

The complexity information for root processes may include a ‘po_root_parameter_type_idc’, ‘po_root_log 2_parameter_bit_length_minus3’, ‘po_root_num_parameters_idc’, ‘po_root_num_kmac_operations_idc’, and ‘po_root_total_kilobyte_size’. These syntax elements function similarly to their sub-chain counterparts described above but apply to the mandatory processing stages of the processing chain. If ‘po_root_num_parameters_idc’ is greater than zero, video decoder 300 may derive a variable ‘maxRootNumParameters’ as follows: ‘maxRootNumParameters=(2048<<po_root_num_parameters_idc)−1’. The number of parameters of root processes may be less than or equal to ‘maxRootNumParameters’.

Additionally or alternatively, video encoder 200 and video decoder 300 may be configured to process SEI messages having the same processing order values but different po_sei_importance_flag and po_sei_processing_degree_flag values as follows. Let seiMsgC be an SEI message that applies as the i-th SEI message type in the processing chain specified in a current SPO SEI message, persists for a particular picture picC, and is associated with po_sei_processing_order[i] equal to po ValC, seiMsgC starts or ends a sub-chain subChainC. Let seiMsgSetC be a set of SEI messages that includes each SEI message for which all of the following conditions are true:
The SEI message applies as the k-th SEI message type in the processing chain specified in this SPO SEI message with any value of k less than i.
The SEI message persists for picC.
po_sei_processing_order[k] is equal to po ValC.
The payloadType value of the SEI message is among the values included in SpoProcessSeiList.

Per techniques of this disclosure, video encoder 200 and video decoder 300 may determine that SEI messages of seiMsgSetC belong to subChainC. Then, video decoder 300 may process the SEI messages of seiMsgSetC after seiMsgC if seiMsgC starts a subChainC, or precede seiMsgC if seiMsgC ends subChainC. The set seiMsgSetC may belong to the sub-chain subChainC. Consequently, video decoder 300 may process the SEI messages of the set seiMsgSetC after the SEI message seiMsgC if seiMsgC starts the sub-chain subChainC, or preceding the SEI message seiMsgC if seiMsgC ends the sub-chain subChainC.

Alternatively, video encoder 200 may be configured to configure a unique po_sei_processing_order[i] value for seiMsgC in the associated SPO SEI message.

Alternatively, video encoder 200 may set the value of po_sei_importance_flag[i] and the value of po_sei_processing_degree_flag[i] to a constant value (such as 0) when the value of po_sei processing_order[i] is equal to the value of po_sei_processing_order[k] where i is not equal to k.

Alternatively, video encoder 200 may facilitate that the i-th SEI message does not start or end a sub-chain when the value of po_sei_processing_order[i] is equal to the value of po_sei processing_order[k] where i is not equal to k.

In some examples, in addition or in the alternative, video encoder 200 may facilitate that the value of po_sei_payload_type is not equal to the payload type of SPO or PON SEI messages.

Additionally or alternatively, video encoder 200 and video decoder 300 may be configured according to a constraint on the po_sei_processing_order value as follows: When more than one SEI message with the same value of po_sei_payload_type, po_sei_wrapping_flag and, when present, po_num_bits_in_prefix_indication_minus1 and po_prefix_data_bit is indicated by a SPO SEI message, the value of po_sei_processing_order shall be the same. Thus, when more than one SEI message with the same value of po_sei_payload_type, po_sei_wrapping_flag and, when present, po_num_bits_in_prefix_indication_minus1 and po_prefix_data_bit is indicated by a SPO SEI message, video encoder 200 may set the value of po_sei_processing_order to be the same.

Alternatively, the constraint may be as follows: A SPO SEI message shall not have more than one SEI messages with the same value of po_sei_payload_type, po_sei_wrapping_flag and, when present, po_num_bits_in_prefix_indication_minus1 and po_prefix_data_bit. Thus, video encoder 200 may prevent an SPO SEI message from having more than one SEI messages with the same value of po_sei_payload_type, po_sei_wrapping_flag and, when present, po_num_bits_in_prefix_indication_minus1 and po_prefix_data_bit

Video encoder 200 may encode video data and generate a supplemental enhancement information (SEI) processing order (SPO) SEI message for the encoded video data. Video encoder 200 may determine a set of syntax elements for the SPO SEI message, including a payload type, a processing order value, and at least one sub-chain indicator for each of a plurality of SEI message types. Video encoder 200 may partition the plurality of SEI messages into one or more sub-chains based on the sub-chain indicator. Video decoder 300 may receive the SPO SEI message and determine a processing chain. Video decoder 300 may partition the processing chain into the one or more sub-chains and process the plurality of SEI messages according to the processing order value and a set of partitions of SEI messages.

Video encoder 200 may set a value for a first syntax element (e.g., a wrapping flag) indicating whether an SEI message is included in a processing order nesting (PON) SEI message. When the wrapping flag indicates the SEI message is not included in the PON SEI message, video encoder 200 may signal a second syntax element (e.g., a prefix flag) indicating presence of prefix bits. Video decoder 300 may determine the value of the wrapping flag and, based on the value, determine whether to process the prefix flag and extract a number of prefix bits.

Video encoder 200 may generate SEI prefix indications such that each indication comprises a bit string containing a number of complete syntax elements, with an exception for ITU-T T.35 payloads and user data payloads. Video decoder 300 may extract complete syntax elements from the bit string in accordance with this constraint.

Video encoder 200 may signal sub-chain usage and complexity information, including parameter types, bit lengths, numbers of operations, and memory sizes. Video decoder 300 may decode this information to select a suitable sub-chain for processing. By providing explicit complexity information for individual sub-chains, such as the number of multiply-accumulate operations or total memory requirements, the SPO SEI message enables video decoder 300 to perform granular resource allocation. In scenarios where the total processing chain exceeds the computational limits of the processing system of destination device 116, the decoder may identify and execute only those sub-chains that fall within its current power or memory capacity. This selective execution may lead to at least a portion of the preferred post-processing being performed to improve video quality, rather than the decoder bypassing the entire enhancement process due to a lack of total chain information. Video encoder 200 may also constrain human viewing and machine analysis indicators in the SPO SEI message to match values in a last-stage Neural-network post-filter characteristics (NNPFC) SEI message.

The techniques described in this disclosure may provide various improvements to video processing systems and devices. By conditioning the presence of the prefix flag on the value of the wrapping flag, video encoder 200 may reduce bitstream redundancy, as prefix bits need not be signaled when the SEI message is already encapsulated within a processing order nesting (PON) SEI message. This reduction in signaling may save bandwidth and improve coding efficiency. Moreover, excluding ITU-T T.35 and user data payloads from strict prefix indication boundary constraints may prevent parsing errors and undefined behavior, thereby providing sufficient data for video decoder 300 to robustly identify processing chains even when these payload types contain externally defined syntax structures.

Furthermore, the explicit signaling of complexity and usage information for individual sub-chains and mandatory processing stages may enable more intelligent resource management by video decoder 300. Instead of discarding an entire processing chain due to complexity limits, video decoder 300 can use the signaled parameters, such as the number of multiply-accumulate operations or memory size, to determine if a specific sub-chain falls within the device capabilities. This granular control may allow video decoder 300 to perform partial post-processing steps that enhance visual quality or machine analysis performance, rather than defaulting to no processing. Aligning the usage indicators in the SPO SEI message with those in the underlying NNPFC or Annotated Regions SEI messages may further equip video decoder 300 to correctly identify the intended application of the processed video content.

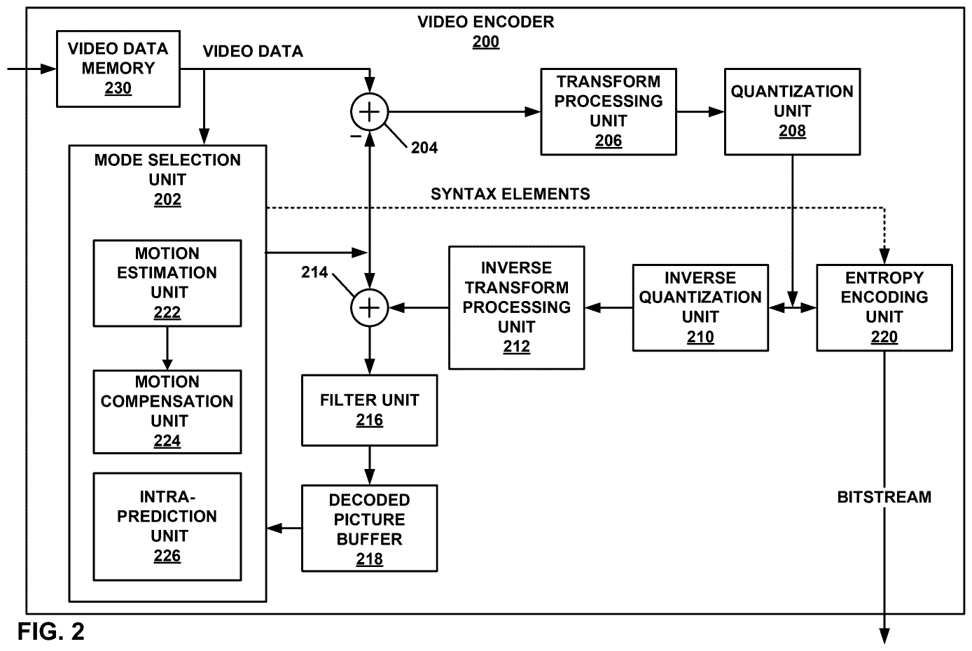

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266) and HEVC (ITU-T H.265). However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUS, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 may generate a supplemental enhancement information (SEI) processing order (SPO) SEI message for inclusion in a video bitstream including encoded video data. Video encoder 200 may determine a processing chain comprising a plurality of SEI message types and partition the plurality of SEI message types into one or more sub-chains. Video encoder 200 may encode a set of syntax elements for each SEI message type, including a payload type, a processing order value, and at least one sub-chain indicator. By signaling the sub-chain indicator, video encoder 200 enables a video decoder, such as video decoder 300, to identify and select specific sub-chains for processing.

Video encoder 200 may determine a value for a wrapping syntax element indicating whether a particular SEI message is included in a processing order nesting (PON) SEI message. When the wrapping syntax element indicates that the SEI message is not included in the PON SEI message, video encoder 200 may encode a prefix flag indicating whether prefix bits are included in the SPO SEI message. Video encoder 200 may omit the prefix flag when the wrapping syntax element indicates inclusion in the PON SEI message.

Video encoder 200 may generate complexity information for the one or more sub-chains and encode the complexity information in the SPO SEI message. The complexity information may include data regarding parameter types, parameter bit lengths, numbers of parameters, numbers of multiply-accumulate operations, or total memory sizes. Video encoder 200 may also determine intended usage values for human viewing or machine analysis and encode these values in the SPO SEI message, ensuring consistency with corresponding values in specific SEI messages such as Neural-network post-filter characteristics (NNPFC) SEI messages.

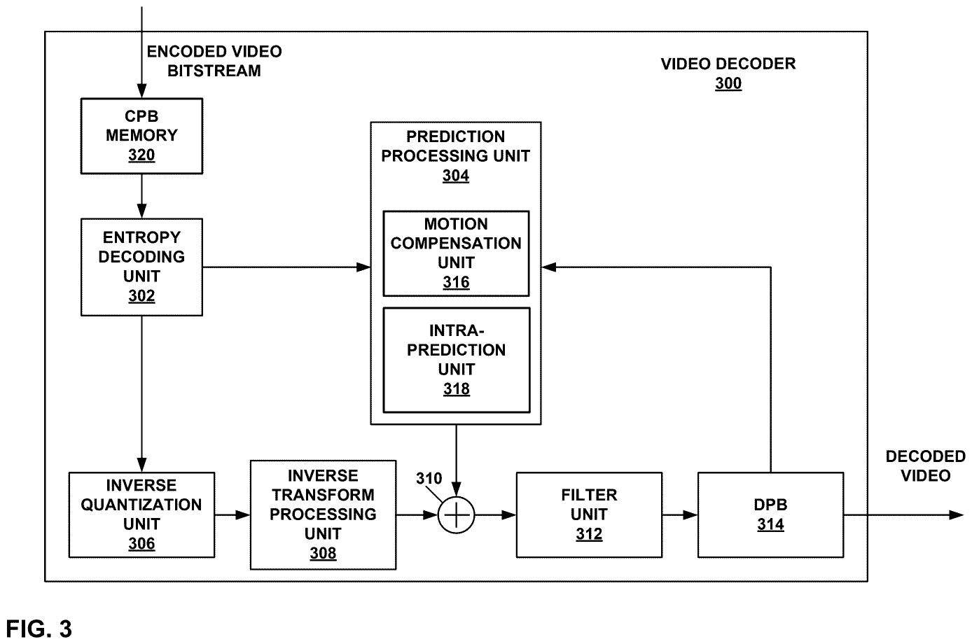

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC (ITU-T H.266) and HEVC (ITU-T H.265). However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may each be provided by the same memory device or separate memory devices or memory units. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

Video decoder 300 may be configured to perform techniques for processing supplemental enhancement information (SEI) messages as described in this disclosure. Video decoder 300 may receive a video bitstream including an SEI processing order (SPO) SEI message. Video decoder 300 may determine a processing chain comprising a plurality of SEI message types based on the SPO SEI message. Video decoder 300 may determine, for each SEI message type, a set of syntax elements including a payload type, a processing order value, and at least one sub-chain indicator. Video decoder 300 may partition the plurality of SEI messages into one or more sub-chains based on the at least one sub-chain indicator to form a set of partitions. Video decoder 300 may process the plurality of SEI messages according to the processing order value and the set of partitions.

Video decoder 300 may determine a value for a first syntax element, such as a wrapping flag, indicating whether a particular SEI message is included in a processing order nesting (PON) SEI message. When the first syntax element indicates that the SEI message is not included in the PON SEI message, video decoder 300 may determine that the SPO SEI message includes a value for a second syntax element, such as a prefix flag. Video decoder 300 may determine whether a third syntax element indicating a number of prefix bits is included based on the second syntax element.

Video decoder 300 may process an SEI prefix indication comprising a bit string that follows an SEI payload syntax of a particular payload type. Video decoder 300 may extract a number of complete syntax elements starting from a first syntax element in the SEI payload from the bit string. Video decoder 300 may apply an exception to this extraction process for SEI message types having a payload type of an ITU-T T.35 payload byte or a user data payload byte.

Video decoder 300 may determine a value of a sub-chain count syntax element specifying a number of sub-chains included in the SPO SEI message. Video decoder 300 may determine a sub-chain syntax element specifying a sub-chain to which an SEI message type belongs. Video decoder 300 may decode complexity information and usage information for the sub-chains to select a sub-chain for processing based on capabilities of video decoder 300.

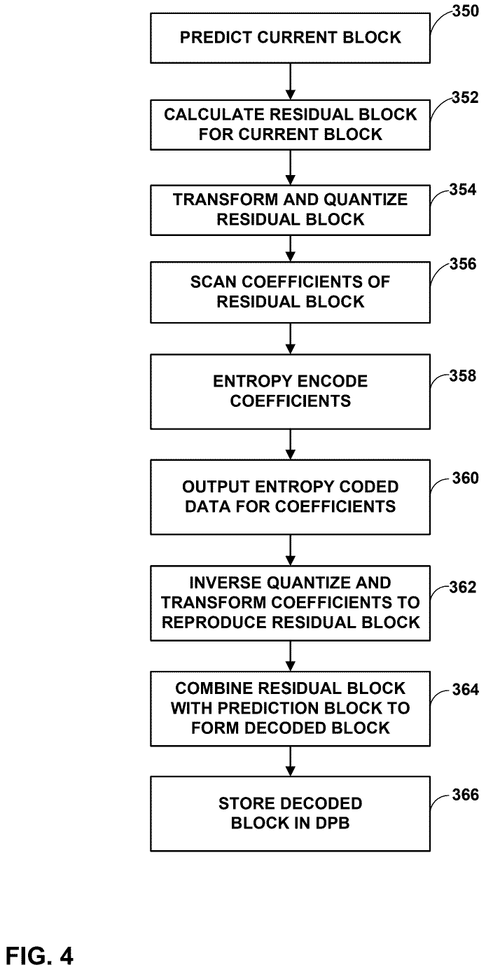

FIG. 4 is a flowchart illustrating an example method for encoding a current block in accordance with the techniques of this disclosure. The current block may include a current CU. Although described with respect to video encoder 200 (FIGS. 1 and 2), it should be understood that other devices may be configured to perform a method similar to that of FIG. 4.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then store the decoded block in DPB 218 (366).

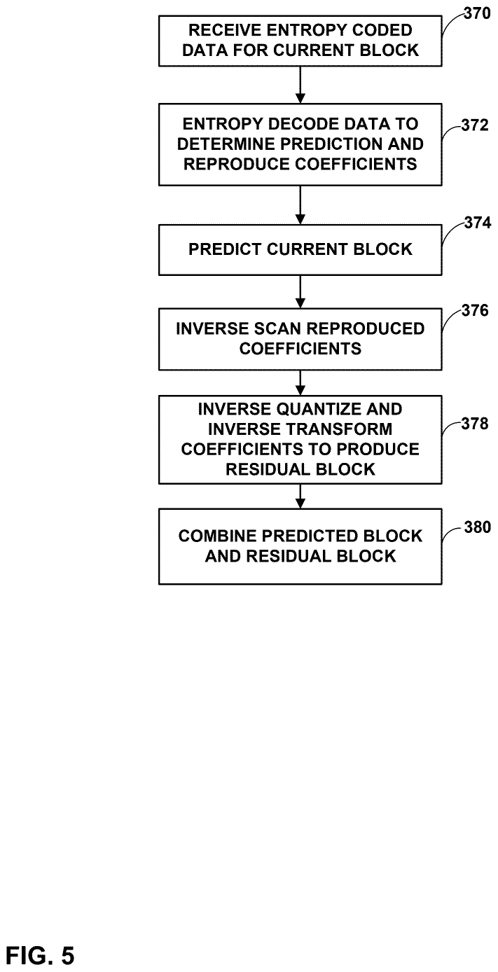

FIG. 5 is a flowchart illustrating an example method for decoding a current block of video data in accordance with the techniques of this disclosure. The current block may include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

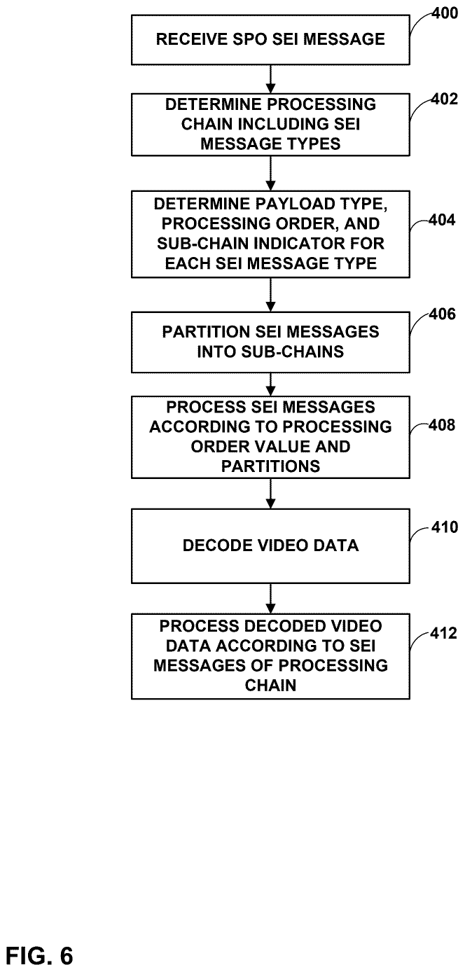

FIG. 6 is a flowchart illustrating an example method of processing a video bitstream including a supplemental enhancement information (SEI) processing order (SPO) SEI message including a payload type, a processing order value, and at least one sub-chain indicator per techniques of this disclosure. Initially, in this example, video decoder 300 receives an SPO SEI message in a video bitstream (400). Video decoder 300 determines a processing chain including a plurality of SEI message types based on the SPO SEI message (402). The processing chain defines a sequence of post-processing operations or metadata handling operations that video decoder 300 may apply to decoded video data.

Video decoder 300 determines, for each SEI message type in the plurality of SEI message types in the SPO SEI message, a set of syntax elements including a payload type, a processing order value, and at least one sub-chain indicator (404). For example, video decoder 300 may parse a po_sei_payload_type[i] syntax element to determine the payload type of the i-th SEI message. Video decoder 300 may parse a po_sei processing_order[i] syntax element to determine the processing order value. Video decoder 300 may parse a sub-chain index syntax element, such as po_sei_subchain_idx[i], which serves as the sub-chain indicator specifying the sub-chain to which the SEI message belongs.

In some examples, video decoder 300 determines a value for a first syntax element of the SPO SEI message for one of the plurality of SEI messages indicating whether the one of the plurality of SEI messages is included in a processing order nesting (PON) SEI message of the video bitstream. For instance, video decoder 300 may parse a po_sei_wrapping_flag[i] syntax element. When the value for the first syntax element indicates that the SEI message is not included in the PON SEI message (e.g., po_sei_wrapping_flag[i] is 0), video decoder 300 may determine that the SPO SEI message includes a value for a second syntax element, such as po_sei_prefix_flag[i]. This second syntax element indicates whether a third syntax element is included for the SEI message in the SPO SEI message. If the second syntax element indicates presence (e.g., po_sei_prefix_flag[i] is 1), video decoder 300 processes the third syntax element (e.g., po_num_bits_in_prefix_indication_minus1[i]) indicating a number of prefix bits included for the SEI message in the SPO SEI message. The number of prefix bits corresponds to a bit string following an SEI payload for the SEI message, and the bit string contains a number of complete syntax elements. Video decoder 300 uses these prefix bits to distinguish between different SEI messages having the same payload type. In some examples, video decoder 300 does not apply this prefix bit logic to SEI message types having a payload type of ITU-T T.35 payload or user data payload.

Video decoder 300 partitions the plurality of SEI messages into one or more sub-chains based on the at least one sub-chain indicator to form a set of partitions of SEI messages (406). Video decoder 300 may group SEI messages sharing the same po_sei_subchain_idx[i] into a single sub-chain partition. Video decoder 300 may also determine usage information and complexity information for each of the one or more sub-chains. For example, video decoder 300 may parse a po_sub_chain_complexity_present_flag to determine if complexity information is available. If available, video decoder 300 may parse syntax elements including at least one of a parameter type (e.g., po_sub_chain_parameter_type_idc), a parameter bit length (e.g., po_sub_chain_log 2_parameter_bit_length_minus3), a number of parameters (e.g., po_sub_chain_num_parameters_idc), a number of multiply-accumulate operations (e.g., po_sub_chain_num_kmac_operations_idc), or a total memory size (e.g., po_sub_chain_total_kilobyte_size). Video decoder 300 may use this information to decide whether to process the sub-chain based on the decoder's capabilities. Video decoder 300 may also determine a value of a syntax element indicating a degree to which decoded video data is intended for human viewing (e.g., po_sub_chain_for_human_viewing_idc) or machine analysis (e.g., po_sub_chain_for_machine_analysis_idc).

Video decoder 300 processes the plurality of SEI messages according to the processing order value and the set of partitions of SEI messages (408). Video decoder 300 decodes video data (410), for example, by generating prediction blocks and combining them with residual blocks. Video decoder 300 processes the decoded video data according to the SEI messages of the processing chain (412). In some examples, video decoder 300 applies a first SEI message and a second SEI message that share a common processing order value but have different importance or processing degree flags. Video decoder 300 may determine that the first SEI message and the second SEI message belong to a common sub-chain in response to the second SEI message having an index in the processing chain lower than an index of the first SEI message in the processing chain.

In this manner, the method of FIG. 6 represents an example of a method of processing video data, including: processing a supplemental enhancement information (SEI) processing order (SPO) SEI message of a video bitstream to determine a processing chain comprising a plurality of SEI message types; determining, for each SEI message type in the plurality of SEI message types in the SPO SEI message, a set of syntax elements including a payload type, a processing order value, and at least one sub-chain indicator; partitioning the plurality of SEI messages into one or more sub-chains based on the at least one sub-chain indicator to form a set of partitions of SEI messages; and processing the plurality of SEI messages according to the processing order value and the set of partitions of SEI messages.

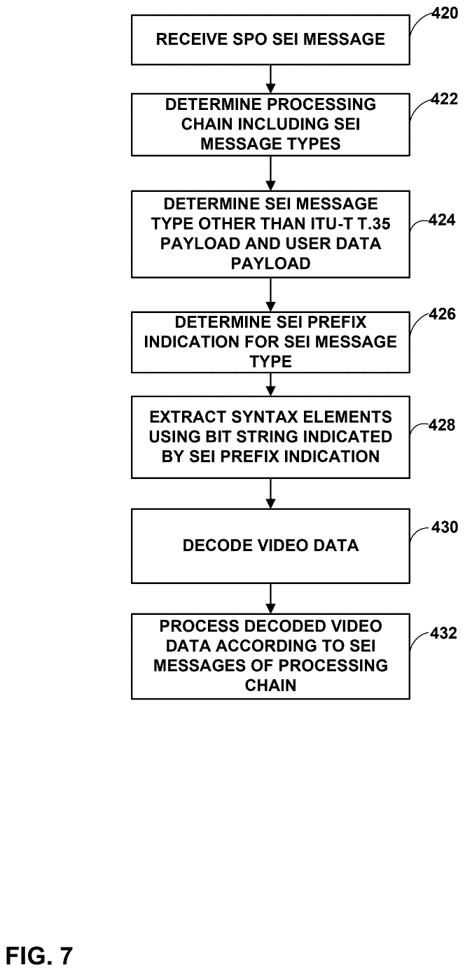

FIG. 7 is a flowchart illustrating an example method of processing a video bitstream including an SPO SEI message including various SEI message types other than those including payload types of ITU-T T.35 payload byte and a user data payload byte per techniques of this disclosure. Video decoder 300 receives the SPO SEI message in the video bitstream (420). Video decoder 300 processes the SPO SEI message to determine a processing chain for a plurality of SEI message types (422).

Video decoder 300 determines whether any of the SEI message types in the processing chain correspond to specific types excluded from certain prefix indication constraints (424). Specifically, video decoder 300 identifies SEI message types that have a payload type other than an ITU-T T.35 payload byte and a user data payload byte. For each SEI message type of the plurality of SEI message types that has a payload type other than an ITU-T T.35 payload byte and a user data payload byte, video decoder 300 determines an SEI prefix indication from the SPO SEI message (426). The SEI prefix indication includes a bit string that follows an SEI payload syntax of a particular payload type. Video decoder 300 extracts a number of complete syntax elements starting from a first syntax element in the SEI payload from the bit string (428). This may cause the prefix indication to provide valid boundaries for syntax elements, except for the excluded types where boundaries are externally defined.

In some examples, video decoder 300 determines a wrapping syntax element indicating whether a corresponding SEI message of the plurality of SEI message types is included in a processing order nesting (PON) SEI message. The wrapping syntax element, such as po_sei_wrapping_flag[i], indicates whether a number of prefix bits and prefix data bits are included in the SPO SEI message for the corresponding SEI message. When the wrapping flag indicates that the corresponding SEI message is not included in the PON SEI message (e.g., the value is 0), video decoder 300 determines that the SPO SEI message includes a prefix flag, such as po_sei_prefix_flag[i], for the corresponding SEI message. Video decoder 300 may parse the prefix flag to determine if prefix data is present for the SEI message in the SPO SEI message.

Video decoder 300 may then decode video data of the video bitstream (430). Video decoder 300 may further process the decoded video data according to the SEI messages of the processing chain defined by the SPO SEI message (432).

In this manner, the method of FIG. 7 represents an example of a method of processing video data, including: processing a supplemental enhancement information (SEI) processing order (SPO) SEI message of a video bitstream to determine a processing chain for a plurality of SEI message types; for each SEI message type of the plurality of SEI message types that has a payload type other than an ITU-T T.35 payload byte and a user data payload byte: determining an SEI prefix indication from the SPO SEI message, the SEI prefix indication comprising a bit string that follows an SEI payload syntax of a particular payload type; and extracting a number of complete syntax elements starting from a first syntax element in the SEI payload from the bit string.

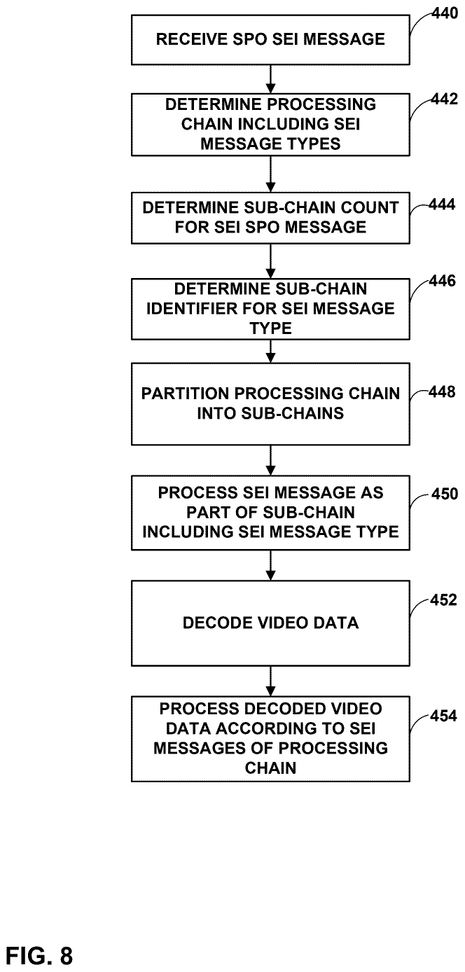

FIG. 8 is a flowchart illustrating an example method of processing a video bitstream including an SPO SEI message including various sub-chains per techniques of this disclosure. Initially, in this example, video decoder 300 receives the SPO SEI message in the video bitstream (440). Video decoder 300 processes the SPO SEI message to determine a processing chain for a plurality of SEI message types (442).

Video decoder 300 then determines a value of a sub-chain count syntax element of the SPO SEI message (444). The value, for example ‘po_num_sub_chain_minus1’, specifies a number of sub-chains included in the SPO SEI message. Video decoder 300 determines, for an SEI message type in the plurality of SEI message types, a sub-chain syntax element specifying a sub-chain to which the SEI message type belongs (446). For instance, video decoder 300 may parse a po_sei_subchain_idx[i] syntax element. In examples where the sub-chain index syntax element is not present for an i-th SEI message type, video decoder 300 may infer a value of the sub-chain index to be equal to i, that is, the index of the i-th SEI message type.

Video decoder 300 partitions the processing chain into one or more sub-chains (448). Video decoder 300 may form a set of partitions of SEI messages based on the sub-chain indicators. Video decoder 300 processes the SEI message type as part of the sub-chain to which the SEI message type belongs (450).

In some examples, video decoder 300 identifies, for a sub-chain of the one or more sub-chains, a usage present flag indicating whether intended usage information for the sub-chain is present in the SPO SEI message. For example, video decoder 300 may parse ‘po_sub_chain_usage_present_flag[i]’. When the usage present flag indicates the intended usage information is present, video decoder 300 processes a sub-chain human viewing indicator (e.g., ‘po_sub_chain_for_human_viewing_idc[i]’) indicating an intended optimal usage for human viewing of video resulting from the sub-chain. Video decoder 300 may also process a sub-chain machine analysis indicator (e.g., ‘po_sub_chain_for_machine_analysis_idc[i]’) indicating an intended optimal usage for machine analysis of video resulting from the sub-chain. In accordance with techniques of the disclosure, a bitstream conformance requirement may specify that the values of po_sub_chain_for_human_viewing_idc and po_sub_chain_for_machine_analysis_idc shall not both be equal to 1. This constraint may ensure that a sub-chain is not simultaneously marked as unsuitable for both human viewing and machine analysis, which would render the sub-chain information functionally irrelevant for the processing system of destination device 116.

Additionally or alternatively, video decoder 300 may determine, for a sub-chain of the one or more sub-chains, a value for a complexity present syntax element indicating whether complexity information for the sub-chain is present in the SPO SEI message. For example, video decoder 300 may parse ‘po_sub_chain_complexity_present_flag[i]’. When the complexity present syntax element flag indicates that the complexity information is present, video decoder 300 may process one or more of a sub-chain parameter type indicator, a sub-chain parameter bit length indicator, a sub-chain number of parameters indicator, a sub-chain number of multiply-accumulate operations indicator, or a sub-chain total memory size indicator for the sub-chain.

Video decoder 300 then decodes video data of the video bitstream (452). Video decoder 300 also processes the decoded video data according to the SEI messages of the processing chain defined by the SPO SEI message (454). For example, video decoder 300 may apply post-processing filters defined by the SEI messages in the order specified by the processing chain and sub-chain partitions.

In this manner, the method of FIG. 8 represents an example of a method of processing video data, including: processing a supplemental enhancement information (SEI) processing order (SPO) SEI message of a video bitstream to determine a processing chain for a plurality of SEI message types; determining a value of a sub-chain count syntax element of the SPO SEI message, the value specifying a number of sub-chains included in the SPO SEI message; determining, for an SEI message type in the plurality of SEI message types, a sub-chain syntax element specifying a sub-chain to which the SEI message type belongs; partitioning the processing chain into one or more sub-chains; and processing the SEI message type as part of the sub-chain to which the SEI message type belongs.

The following clauses represent various examples of the techniques of this disclosure:

Clause 1: A method of decoding video data, the method comprising: determining a value for a first syntax element of a supplemental enhancement information (SEI) processing order (SPO) SEI message of a video bitstream, the first syntax element indicating whether an SEI message of the video bitstream is included in a processing order nesting (PON) SEI message of the video bitstream; and when the value for the first syntax elements indicates that the SEI message is not included in the PON SEI message, determining that the SPO SEI message includes a value for a second syntax element, the second syntax element indicating whether a third syntax element is included for the SEI message in the SPO SEI message, the third syntax element indicating a number of prefix bits included for the SEI message in the SPO SEI message.

Clause 2: The method of clause 1, wherein the number of prefix bits included for the SEI message corresponds to a bit string following an SEI payload for the SEI message and contains a number of complete syntax elements.

Clause 3: The method of any of clauses 1 and 2, wherein the SEI message is not an ITU-T T.35 SEI message and is not a user data payload.

Clause 4: The method of any of clauses 1-3, wherein when the value for the first syntax elements indicates that the SEI message is included in the PON SEI message, determining that the SPO SEI message does not include the value for the second syntax element.

Clause 5: The method of any of clauses 1-4, wherein the first syntax element comprises a po_sei_wrapping_flag[i] syntax element, the second syntax element comprises a po_sei_prefix_flag[i] syntax element, and the third syntax element comprises a po_num_bits_in_prefix_indication_minus1[i] syntax element.

Clause 6: The method of any of clauses 1-5, further comprising determining that a po_for_human_viewing_idc syntax element has a value equal to a value for a nnpfc_for_machine_analysis_idc of a Neural-network post-filter characteristics (NNPFC) SEI message associated with the SPO SEI message.

Clause 7: The method of any of clauses 1-6, further comprising determining that a po_for_machine_analysis_idc syntax element has a value equal to a value for a nnpfc_for_machine_analysis_idc of a Neural-network post-filter characteristics (NNPFC) SEI message associated with the SPO SEI message.

Clause 8: The method of any of clauses 6 and 7, further comprising determining that the NNPFC SEI message has a greatest value for a po_sei_processing_order syntax element among SEI messages associated with the SPO SEI message.

Clause 9: The method of any of clauses 6 and 7, further comprising determining that the NNPFC SEI message is an i^{th} SEI message where i is equal to po_num_sei_messages_minus2+1.

Clause 10: The method of any of clauses 6 and 7, further comprising determining that the NNPFC SEI messages corresponds to a mandatory processing stage of the SPO SEI message.

Clause 11: The method of any of clauses 1-10, further comprising determining that a po_for_human_viewing_idc syntax element has a value equal to a value for a eoi_for_human_viewing_idc syntax element of an encoder optimization information (EOI) SEI message associated with the SPO SEI message.

Clause 12: The method of any of clauses 1-11, further comprising determining that a po_for_machine_analysis_idc syntax element has a value equal to a value for a eoi_for_machine_analysis_idc syntax element of an encoder optimization information (EOI) SEI message associated with the SPO SEI message.

Clause 13: The method of any of clauses 11 and 12, further comprising determining that the EOI SEI message has a greatest value for a po_sei_processing_order syntax element among SEI messages associated with the SPO SEI message.

Clause 14: The method of any of clauses 11 and 12, further comprising determining that the EOI SEI message is a (po_num_sei_messages_minus2+1)-th SEI message of SEI messages associated with the SPO SEI message.

Clause 15: The method of any of clauses 11 and 12, further comprising determining that the EOI SEI message corresponds to a mandatory processing stage of the SPO SEI message.

Clause 16: The method of any of clauses 1-15, further comprising determining that a po_for_human_viewing_idc syntax element has a value other than 3.

Clause 17: The method of clause 16, further comprising determining that an ar_not_optimized_for_viewing_flag of an Annotated Regions (AR) SEI message associated with the SPO SEI message has a greatest value of po_sei_processing_order among SEI messages associated with the SPO SEI message.

Clause 18: The method of clause 16, further comprising determining that the AR SEI message is an (po_num_sei_messages_minus2+1)-th SEI message.

Clause 19: The method of clause 16, further comprising determining that a po_sei_processing_order syntax element of the AR SEI message corresponds to a mandatory processing stage of the SPO SEI message and the value of an ar_not_optimized_for_viewing_flag is equal to 1.

Clause 20: The method of any of clauses 1-19, further comprising determining a value of a fourth syntax element of the SPO SEI message, the fourth syntax element indicating a number of sub-chains of a processing chain corresponding to the SPO SEI message.

Clause 21: The method of clause 20, wherein the fourth syntax element comprises po_num_sub_chain_minus1.

Clause 22: The method of any of clauses 20 and 21, further comprising determining, for each of a plurality of SEI messages associated with the SPO SEI message, a sub-chain index to which the SEI message belongs.

Clause 23: The method of clause 22, wherein determining the sub-chain index comprises determining a value for a fifth syntax element of the SPO SEI message, the fifth syntax element indicating the sub-chain index to which the SEI message belongs.

Clause 24: The method of clause 23, wherein the fifth syntax element comprises po_sei_subchain_idx[i].

Clause 25: The method of any of clauses 1-24, further comprising: generating a prediction block for a current block of the video data; decoding a residual block for the current block of the video data; combining the prediction block with the residual block to decode the current block of the video data; and after decoding the video data, processing the video data using the SPO SEI message and the PON SEI message.

Clause 26: The method of any of clauses 1-24, further comprising: generating a prediction block for a current block of the video data; and encoding a residual block for the current block of the video data, the residual block representing differences between the current block and the prediction block.

Clause 27: The method of clause 26, further comprising forming SEI messages of type seiMsgSetC to belong to subChainC.

Clause 28: The method of clause 26, further comprising forming SEI messages of type seiMsgSetC to each have a unique value for a po_sei processing_order[i] in the SPO SEI message.

Clause 29: The method of any of clauses 26-28, further comprising constructing SEI messages corresponding to the SPO SEI message such that po_sei_payload_type values for the SEI messages are different than a payload type of the SPO SEI message and a payload type of the PON SEI message.

Clause 30: The method of any of clauses 26-29, further comprising, for any two SEI messages having common values for po_sei_payload_type, po_sei_wrapping_flag and, when present, po_num_bits_in_prefix_indication_minus1, and when po_prefix_data_bit are indicated by the SPO SEI message, setting values of po_sei_processing_order syntax elements of the two SEI messages to be the same.

Clause 31: A device for decoding video data, the device comprising one or more means for performing the method of any of clauses 1-30.

Clause 32: The device of clause 31, further comprising a display configured to display the decoded video data.

Clause 33: The device of any of clauses 31 and 32, wherein the device comprises one or more of a camera, a computer, a mobile device, a broadcast receiver device, or a set-top box.

Clause 34: The device of any of clauses 31-33, further comprising a memory configured to store the video data.

Clause 35: A computer-readable storage medium having stored thereon instructions that, when executed, cause a processor of a device for decoding video data to perform the method of any of clauses 1-30.

Clause 36: A device for decoding video data, the device comprising: means for determining a value for a first syntax element of a supplemental enhancement information (SEI) processing order (SPO) SEI message of a video bitstream, the first syntax element indicating whether an SEI message of the video bitstream is included in a processing order nesting (PON) SEI message of the video bitstream; and means for determining, when the value for the first syntax elements indicates that the SEI message is not included in the PON SEI message, that the SPO SEI message includes a value for a second syntax element, the second syntax element indicating whether a third syntax element is included for the SEI message in the SPO SEI message, the third syntax element indicating a number of prefix bits included for the SEI message in the SPO SEI message.

Clause 37: A method of processing video data, the method comprising: processing a supplemental enhancement information (SEI) processing order (SPO) SEI message of a video bitstream to determine a processing chain comprising a plurality of SEI message types; determining, for each SEI message type in the plurality of SEI message types in the SPO SEI message, a set of syntax elements including a payload type, a processing order value, and at least one sub-chain indicator; partitioning the plurality of SEI messages into one or more sub-chains based on the at least one sub-chain indicator to form a set of partitions of SEI messages; and processing the plurality of SEI messages according to the processing order value and the set of partitions of SEI messages.

Clause 38: The method of clause 37, further comprising processing a first syntax element of the SPO SEI message for one of the plurality of SEI messages indicating whether the one of the plurality of SEI messages is included in a processing order nesting (PON) SEI message of the video bitstream, wherein when the one of the plurality of SEI messages is not included in the PON SEI message, the method further comprises processing a second syntax element indicating a number of prefix bits included for the one of the plurality of SEI messages in the SPO SEI message, the number of prefix bits corresponding to a bit string following an SEI payload for the one of the plurality of SEI messages, the bit string containing a number of complete syntax elements.

Clause 39: The method of clause 38, wherein the first syntax element comprises a po_sei_wrapping_flag[i] syntax element.

Clause 40: The method of any of clauses 37-39, wherein the plurality of SEI messages excludes ITU-T T.35 SEI messages and user data payload SEI messages.

Clause 41: The method of any of clauses 37-40, wherein the at least one sub-chain indicator comprises a sub-chain index syntax element for each SEI message of the plurality of SEI messages to which the SEI message belongs.

Clause 42: The method of any of clauses 37-41, further comprising decoding usage information and complexity information for each of the one or more sub-chains, the complexity information including at least one of a parameter type, a parameter bit length, a number of parameters, a number of multiply-accumulate operations, or a total memory size.

Clause 43: The method of any of clauses 37-42, further comprising: determining a first SEI message of the plurality of SEI messages and a second SEI message of the plurality of SEI messages that share a common processing order value and have different importance or processing degree flags; and determining that the first SEI message and the second SEI message belong to a common sub-chain in response to the second SEI message having an index in the processing chain lower than an index of the first SEI message in the processing chain.

Clause 44: The method of any of clauses 37-43, further comprising determining a value of a syntax element of the SPO SEI message indicating a degree to which decoded video data of the video bitstream is intended for human viewing.

Clause 45: The method of any of clauses 37-44, further comprising determining a value of a syntax element of the SPO SEI message indicating a degree to which decoded video data of the video bitstream is intended for machine analysis.

Clause 46: A method of processing video data, the method comprising: processing a supplemental enhancement information (SEI) processing order (SPO) SEI message of a video bitstream to determine a processing chain for a plurality of SEI message types; for each SEI message type of the plurality of SEI message types that has a payload type other than an ITU-T T.35 payload byte and a user data payload byte: determining an SEI prefix indication from the SPO SEI message, the SEI prefix indication comprising a bit string that follows an SEI payload syntax of a particular payload type; and extracting a number of complete syntax elements starting from a first syntax element in the SEI payload from the bit string.

Clause 47: The method of clause 46, further comprising: determining a wrapping syntax element indicating whether a corresponding SEI message of the plurality of SEI message types is included in a processing order nesting (PON) SEI message; and determining that the SPO SEI message includes a prefix flag (po_sei_prefix_flag[i]) for the corresponding SEI message when the wrapping flag indicates that the corresponding SEI message is not included in the PON SEI message.

Clause 48: The method of clause 47, wherein the wrapping syntax element indicates whether a number of prefix bits and prefix data bits are included in the SPO SEI message for the corresponding SEI message.

Clause 49: A method of processing video data, the method comprising: processing a supplemental enhancement information (SEI) processing order (SPO) SEI message of a video bitstream to determine a processing chain for a plurality of SEI message types; determining a value of a sub-chain count syntax element of the SPO SEI message, the value specifying a number of sub-chains included in the SPO SEI message; determining, for an SEI message type in the plurality of SEI message types, a sub-chain syntax element specifying a sub-chain to which the SEI message type belongs; partitioning the processing chain into one or more sub-chains; and processing the SEI message type as part of the sub-chain to which the SEI message type belongs.

Clause 50: The method of clause 49, comprising identifying, for a sub-chain of the one or more sub-chains, a usage present flag indicating whether intended usage information for the sub-chain is present in the SPO SEI message.

Clause 51: The method of clause 50, further comprising, when the usage present flag indicates the intended usage information is present: processing a sub-chain human viewing indicator indicating an intended optimal usage for human viewing of video resulting from the sub-chain; and processing a sub-chain machine analysis indicator indicating an intended optimal usage for machine analysis of video resulting from the sub-chain.

Clause 52: The method of any of clauses 49-51, further comprising determining, for a sub-chain of the one or more sub-chains, a value for a complexity present syntax element indicating whether complexity information for the sub-chain is present in the SPO SEI message.

Clause 53: The method of clause 52, wherein when the complexity present syntax element flag indicates that the complexity information is present, the method further comprises processing one or more of a sub-chain parameter type indicator, a sub-chain parameter bit length indicator, a sub-chain number of parameters indicator, a sub-chain number of multiply-accumulate operations indicator, or a sub-chain total memory size indicator for the sub-chain.

Clause 54: The method of any of clauses 49-53, wherein when the sub-chain index syntax element is not present for an i-th SEI message type, inferring a value of the sub-chain index to be equal to i.

Clause 55: The method of any of clauses 37-54, further comprising decoding video data using one or more SEI messages of the plurality of SEI message types.

Clause 56: A device for decoding video data, the device comprising one or more means for performing the method of any of clauses 1-55.

Clause 57: The device of clause 56, wherein the one or more means comprise a processing system implemented in circuitry.

Clause 58: The device of any of clauses 56 and 57, further comprising a display configured to display the decoded video data.

Clause 59: The device of any of clauses 56-58, wherein the device comprises one or more of a camera, a computer, a mobile device, a broadcast receiver device, or a set-top box.

Clause 60: The device of any of clauses 56-59, further comprising a memory configured to store the video data.

Clause 61: A computer-readable storage medium having stored thereon instructions that, when executed, cause a processor of a device for decoding video data to perform the method of any of clauses 1-55.

Clause 62: A device for processing video data, the device comprising: a memory configured to store video data; and a processing system implemented in circuitry and configured to: process a supplemental enhancement information (SEI) processing order (SPO) SEI message of a video bitstream to determine a processing chain comprising a plurality of SEI message types; determine, for each SEI message type in the plurality of SEI message types in the SPO SEI message, a set of syntax elements including a payload type, a processing order value, and at least one sub-chain indicator; process the plurality of SEI messages into one or more sub-chains based on the at least one sub-chain indicator to form a set of partitions of SEI messages; and process the plurality of SEI messages according to the processing order value and the set of partitions of SEI messages.

Clause 63: The device of clause 62, wherein the processing system is further configured to: process a first syntax element of the SPO SEI message for one of the plurality of SEI messages indicating whether the one of the plurality of SEI messages is included in a processing order nesting (PON) SEI message of the video bitstream; and when the one of the plurality of SEI messages is not included in the PON SEI message, process a second syntax element indicating a number of prefix bits included for the one of the plurality of SEI messages in the SPO SEI message, the number of prefix bits corresponding to a bit string following an SEI payload for the one of the plurality of SEI messages, the bit string containing a number of complete syntax elements.

Clause 64: The device of clause 63, wherein the first syntax element comprises a po_sei_wrapping_flag[i] syntax element.

Clause 65: The device of any of clauses 62-64, wherein the plurality of SEI messages excludes ITU-T T.35 SEI messages and user data payload SEI messages.

Clause 66: The device of any of clauses 62-65, wherein the at least one sub-chain indicator comprises a sub-chain index syntax element for each SEI message of the plurality of SEI messages to which the SEI message belongs.

Clause 67: The device of any of clauses 62-66, wherein the processing system is further configured to decode usage information and complexity information for each of the one or more sub-chains, the complexity information including at least one of a parameter type, a parameter bit length, a number of parameters, a number of multiply-accumulate operations, or a total memory size.

Clause 68: The device of any of clauses 62-67, wherein the processing system is further configured to: determine a first SEI message of the plurality of SEI messages and a second SEI message of the plurality of SEI messages that share a common processing order value and have different importance or processing degree flags; and determine that the first SEI message and the second SEI message belong to a common sub-chain in response to the second SEI message having an index in the processing chain lower than an index of the first SEI message in the processing chain.

Clause 69: The device of any of clauses 62-68, wherein the processing system is further configured to determine a value of a syntax element of the SPO SEI message indicating a degree to which decoded video data of the video bitstream is intended for human viewing.

Clause 70: The device of any of clauses 62-69, wherein the processing system is further configured to determine a value of a syntax element of the SPO SEI message indicating a degree to which decoded video data of the video bitstream is intended for machine analysis.

Clause 71: The device of any of clauses 62-70, further comprising a display configured to display decoded video data.

Clause 72: The device of any of clauses 62-71, wherein the device comprises one or more of a camera, a computer, a mobile device, a broadcast receiver device, or a set-top box.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
processing a supplemental enhancement information (SEI) processing order (SPO) SEI message of a video bitstream to determine a processing chain comprising a plurality of SEI message types;
determining, for each SEI message type in the plurality of SEI message types in the SPO SEI message, a set of syntax elements including a payload type, a processing order value, and at least one sub-chain indicator;
partitioning the plurality of SEI message types into one or more sub-chains based on the at least one sub-chain indicator to form a set of partitions of SEI message types; and
processing the plurality of SEI message types according to the processing order value and the set of partitions of SEI message types.

2. The method of claim 1, further comprising processing a first syntax element of the SPO SEI message for one of the plurality of SEI message types indicating whether the one of the plurality of SEI message types is included in a processing order nesting (PON) SEI message of the video bitstream, wherein when the one of the plurality of SEI message types is not included in the PON SEI message, the method further comprises processing a second syntax element indicating a number of prefix bits included for the one of the plurality of SEI message types in the SPO SEI message, the number of prefix bits corresponding to a bit string following an SEI payload for the one of the plurality of SEI message types, the bit string containing a number of complete syntax elements.

3. The method of claim 2, wherein the first syntax element comprises a po_sei_wrapping_flag[i] syntax element.

4. The method of claim 1, wherein the plurality of SEI message types exclude SEI message types having a payload type of ITU-T T.35 payload and user data payload.

5. The method of claim 1, wherein the at least one sub-chain indicator comprises a sub-chain index syntax element for each SEI message of the plurality of SEI message types to which the SEI message belongs.

6. The method of claim 1, further comprising decoding usage information and complexity information for each of the one or more sub-chains, the complexity information including at least one of a parameter type, a parameter bit length, a number of parameters, a number of multiply-accumulate operations, or a total memory size.

7. The method of claim 1, further comprising:
determining a first SEI message of the plurality of SEI message types and a second SEI message of the plurality of SEI message types that share a common processing order value and have different importance or processing degree flags; and
determining that the first SEI message and the second SEI message belong to a common sub-chain in response to the second SEI message having an index in the processing chain lower than an index of the first SEI message in the processing chain.

8. The method of claim 1, further comprising determining a value of a syntax element of the SPO SEI message indicating a degree to which decoded video data of the video bitstream is intended for human viewing.

9. The method of claim 1, further comprising determining a value of a syntax element of the SPO SEI message indicating a degree to which decoded video data of the video bitstream is intended for machine analysis.

10. A device for processing video data, the device comprising:
a memory configured to store video data; and
a processing system implemented in circuitry and configured to:
process a supplemental enhancement information (SEI) processing order (SPO) SEI message of a video bitstream to determine a processing chain comprising a plurality of SEI message types;
determine, for each SEI message type in the plurality of SEI message types in the SPO SEI message, a set of syntax elements including a payload type, a processing order value, and at least one sub-chain indicator;
process the plurality of SEI message types into one or more sub-chains based on the at least one sub-chain indicator to form a set of partitions of SEI message types; and
process the plurality of SEI message types according to the processing order value and the set of partitions of SEI message types.

11. The device of claim 10, wherein the processing system is further configured to:
process a first syntax element of the SPO SEI message for one of the plurality of SEI message types indicating whether the one of the plurality of SEI message types is included in a processing order nesting (PON) SEI message of the video bitstream; and
when the one of the plurality of SEI message types is not included in the PON SEI message, process a second syntax element indicating a number of prefix bits included for the one of the plurality of SEI message types in the SPO SEI message, the number of prefix bits corresponding to a bit string following an SEI payload for the one of the plurality of SEI message types, the bit string containing a number of complete syntax elements.

12. The device of claim 11, wherein the first syntax element comprises a po_sei_wrapping_flag[i] syntax element.

13. The device of claim 10, wherein the plurality of SEI message types exclude SEI message types having a payload type of ITU-T T.35 payload and user data payload.

14. The device of claim 10, wherein the at least one sub-chain indicator comprises a sub-chain index syntax element for each SEI message of the plurality of SEI message types to which the SEI message belongs.

15. The device of claim 10, wherein the processing system is further configured to decode usage information and complexity information for each of the one or more sub-chains, the complexity information including at least one of a parameter type, a parameter bit length, a number of parameters, a number of multiply-accumulate operations, or a total memory size.

16. The device of claim 10, wherein the processing system is further configured to:
determine a first SEI message of the plurality of SEI message types and a second SEI message of the plurality of SEI message types that share a common processing order value and have different importance or processing degree flags; and
determine that the first SEI message and the second SEI message belong to a common sub-chain in response to the second SEI message having an index in the processing chain lower than an index of the first SEI message in the processing chain.

17. The device of claim 10, wherein the processing system is further configured to determine a value of a syntax element of the SPO SEI message indicating a degree to which decoded video data of the video bitstream is intended for human viewing.

18. The device of claim 10, wherein the processing system is further configured to determine a value of a syntax element of the SPO SEI message indicating a degree to which decoded video data of the video bitstream is intended for machine analysis.

19. The device of claim 10, further comprising a display configured to display decoded video data.

20. The device of claim 10, wherein the device comprises one or more of a camera, a computer, a mobile device, a broadcast receiver device, or a set-top box.
